(19) United States
(12) Patent Application Publication
(10) Pub. No.: US 2014/0151458 A1
(43) Pub. Date: Jun. 5, 2014

(54) ULTRASONICALLY ENHANCED FUEL-INJECTION METHODS AND SYSTEMS

(71) Applicant: Daniel Gross, New York, NY (US)

(72) Inventor: Daniel Gross, New York, NY (US)

(73) Assignee: RIVERSIDE RESEARCH INSTITUTE, New York, NY (US)

(21) Appl. No.: 13/899,304

(22) Filed: May 21, 2013

Related U.S. Application Data
(60) Provisional application No. 61/649,533, filed on May 21, 2012.

(51) Int. Cl. F02M 51/06

(52) U.S. Cl. CPC F02M 51/0603
USPC 239/4

(57) ABSTRACT

Fuel injectors of varying modes, shear or thickness, and megahertz are used to reduce the size of fuel droplets. The fuel injector has an expansion chamber and an orifice-containing face plate with a porous PZT material arranged adjacent to the face plate. The fuel passes through the porous PZT material as the PZT material is energized to realize reduced fuel particle size.

### FIELD OF THE INVENTION

The present invention relates to methods and systems for decreasing droplet size and increasing fuel economy by combustion engines.

### BACKGROUND OF THE INVENTION

Increased fuel economy in combustion engines has been the topic of extensive research for decades. Currently, droplet size is the dominant factor in incomplete combustion of fuel in engines The center of large droplets is not exposed to oxygen, and not completely oxidized, resulting in wasted fuel. These large droplets contribute to pollution as they get broken down into soot, NOₓ, and CO.

Two ways are commonly available to decrease droplet size when spraying fluid through the small holes on the face of fuel injectors: increase the fuel-rail pressure or decrease the orifice size. Decreasing the orifice size can lead to clogging and requires very high pressures to provide sufficient fuel in high-consumption circumstances. Although larger orifices avoid clogging, they do not produce small droplets under low-consumption circumstances. High-pressure systems also require the use of a high-pressure fuel pump, which imposes a considerable parasitic load on the engine and also potentially may increase fuel-plume penetration to the point of wetting the cylinder walls in reciprocating engines.

Currently, to achieve adequate atomization, gasoline-direct-injection (GDI) engine-design aims for droplets of a maximum Sauter mean diameter (SMD) of 15 to 25 μm, and fuel-rail pressure from 5 MPa to 13 MPa. SMD is a conventional unit of measurement of droplets that takes into account non-uniform droplet shape. Injectors that provide droplets centered in this range, but also exceed it, will not perform as well as desired; a 50-μm droplet not only has 8 times the mass of a 25-μtm droplet, but it takes much longer to evaporate. For example, even after all of the 25-μm droplets have evaporated, 50-μm droplets formed at the same time will only have evaporated enough fuel to have a diameter of 47 μm. Using increased pressure alone on a Delphi outwardly opening GDI injector (FIGS. 1 and 2) demonstrated that doubling the pressure from 5 to 10 megapascals (MPa, 1 MPa=9.9 atmospheres) decreased the SMD from 15.4 82 m to 13.6 μm. This doubling of pressure increased surface area of the droplet collection by 13%. Such a slight decrease in droplet SMD provides a dramatic effect in evaporation rates before oxidation begins and in the total surface area available for oxidation. However, a method is desired that uses ultrasound-assisted atomization to provide an impact on fuel economy.

FIGS. 6 and 7 demonstrate the significant effect that initial SMD has on evaporation rates. Using a simplified model for atomization that ignores thermodynamics, these figures demonstrate that, for the specific conditions modeled, holding fuel mass constant and halving the initial droplet SMD would lead to a 15% increase in the amount of energy extracted from a given amount of fuel. Including thermodynamics would help the demonstration by removing heat from each droplet in proportion to the atomized mass, and hence highlights the phenomenon where small droplets evaporate much faster than large droplets. Thus, a slight decrease in droplet SMD provides a dramatic effect on the total surface area available for oxidation, and hence in evaporation rates before oxidation begins. This occurrence provides beneficial impact on fuel economy and engine output.

One modification to a fuel injector for jet engines has been developed in which a MEMS (microeletromechanical machine) device is vibrated within the injector body in order to break up the droplets. Mean droplet diameter was decreased from ˜100 to ˜14 μm in some of the test conditions. However, a method is desired that would not require a redesign of fuel injector bodies or orifices, and it would be variable enough to allow tuning for different engine conditions, all while greater amounts of energy is delivered to the fuel system with less electrical power.

A method is desired that provides simple modifications to existing fuel injectors. Such a method will decrease droplet size through the use of piezoelectric materials vibrating at ultrasonic frequencies. A method is desired that will leverage and enhance existing designs related to orifice shape and location. A method is desired that will allow for the use of larger orifices in fuel injectors. A method is desired that will simplify construction. A method is desired that will reduce clogging. A method is further desired that will reduce the complexity of fuel line systems, particularly in low-vapor-pressure systems. A method is further desired that will provide fuel injectors that conserve energy and improve performance in liquid-fueled engines (including diesel and gasoline engines) and turbines.

A method is desired also to demonstrate the feasibility of ultrasonically delivering energy into the injected fuel for the purpose of reducing injected-droplet size and thereby markedly increasing fuel-burning efficiency and engine performance. This exemplary aim applies to liquid fuels injected into a wide range of internal-combustion engine types. Success in achieving this exemplary aim will establish a new technology with energy-conserving and performance-improving benefits in liquid-fueled internal-combustion engines of all types.

### SUMMARY OF THE INVENTION

Fuel injectors are modified to decrease fuel-droplet size and consequently increase fuel efficiency in combustion engines of all types including, but not limited to, GDI engines as well as spray-atomized engines such as automobiles, jet engines and oil burning power plants.

### DESCRIPTION OF THE DRAWINGS

FIG. 1 shows a cross section of a fuel injector of the prior art.

FIG. 2 shows a face plate of the prior art fuel injector shown in FIG. 1.

FIG. 3 shows a face plate of a fuel injector according to one embodiment of the present invention.

FIG. 4 shows a face plate of a fuel injector according to a second embodiment of the present invention. The three configurations of orifice-bearing plate along with the 0.125″ diameter adaptor plate which is third from top.

FIG. 5 shows a face plate of a fuel injector according to a third embodiment of the present invention.

FIG. 6 shows SMD evaporation rates with an initial SMD of 50 micrometer.

FIG. 7 shows SMD evaporation rates with an initial SMD of 25 micrometer

FIG. 8 shows four face plate modifications.

FIG. 9 shows graphical result of initial testing using a particle-size analyzer to qualitatively determine changes in injected-droplet size.

FIG. 10 shows normalized particle size distribution for a 1.95 MHz fuel injector

FIG. 11 shows normalized particle size distribution for a 2.93 MHz fuel injector

FIG. 12 shows normalized particle size distribution for a 1.85 MHz fuel injector.

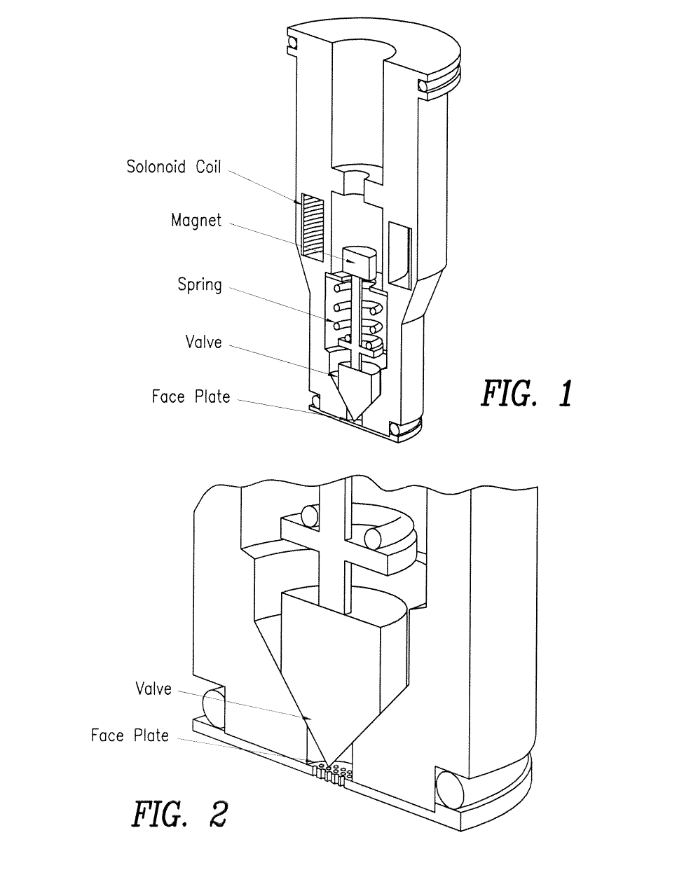

### DESCRIPTION OF THE INVENTION

The methods and systems of enhancing fuel injection of the present invention employs ultrasound-induced changes in the Reynolds number of injected fuel for the purpose of reducing injected-droplet size and thereby increasing fuel-burning efficiency. The present invention increases the Reynolds number of the fuel droplets through momentum transfer. The Reynolds number is the ratio of the inertial force of the individual particles to the viscous forces of the droplet. An important viscous parameter is surface tension. When the spread in inertial energy exceeds the surface tension, the droplet breaks apart.

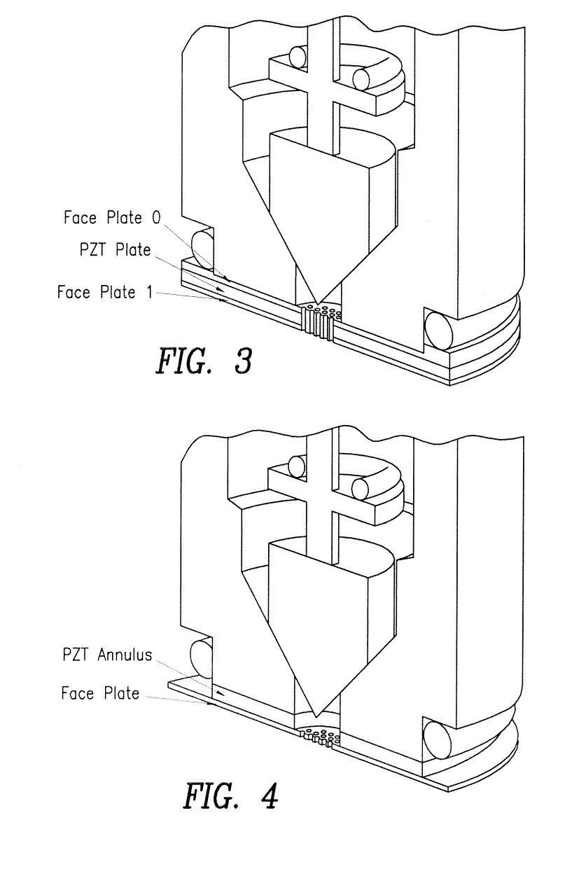

The present invention provides injector configurations that use ultrasound within the injector body to induce cavitation and turbulence in the fuel and hence reduce the SMD of the injected fuel droplets. In a first embodiment, an active element and stainless steel protective plate is used as the orifice-containing face of the fuel injector. Fuel passes through the active element and the frequency and fuel-expansion chamber length is chosen to maximize standing waves. See FIG. 3. In a second embodiment, the active element is an annulus vibrating in the thickness mode inserted below the existing face plate of the injector and vibrating the plate. Frequency and fuel-expansion chamber length is chosen to maximize standing waves. See FIG. 4. The second embodiment keeps the orifice length small and allows changing the expansion-chamber volume in addition to oscillating the exit face of the injector. Prior art fuel injectors have open times that range from 1 millisecond at idle to 20 milliseconds at high engine loads. In comparison, the second injector embodiment in FIG. 4 operates at 2 MHz, which would allow it to subject the small fuel mass, i.e., typically ˜14 mg, to between 2,000 and 40,000 cycles per injection.

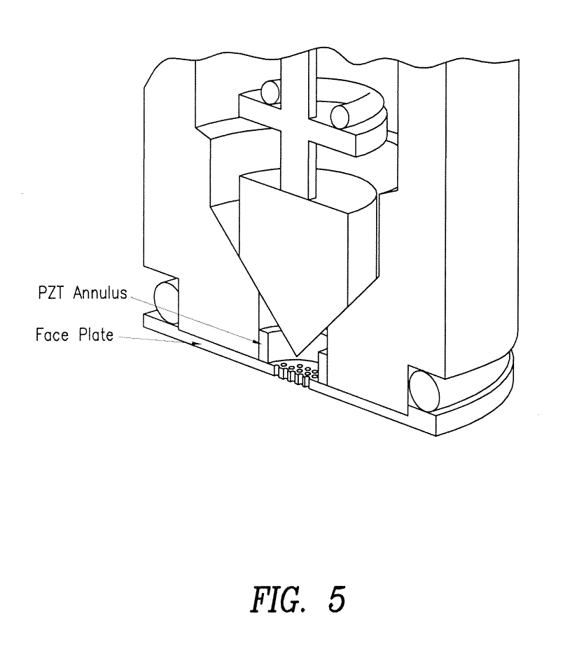

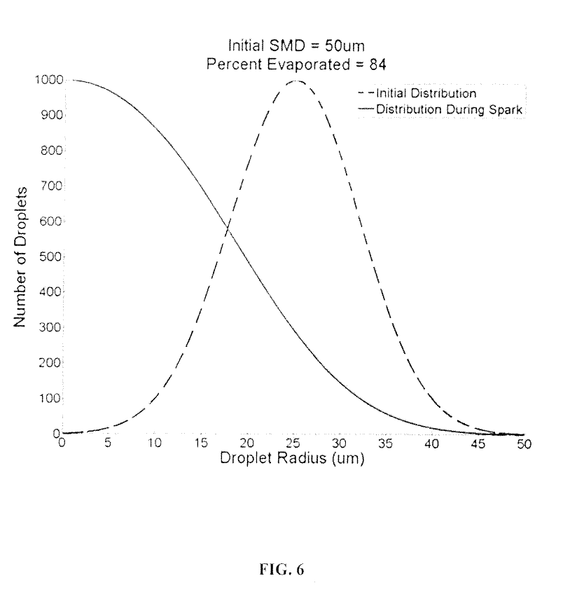

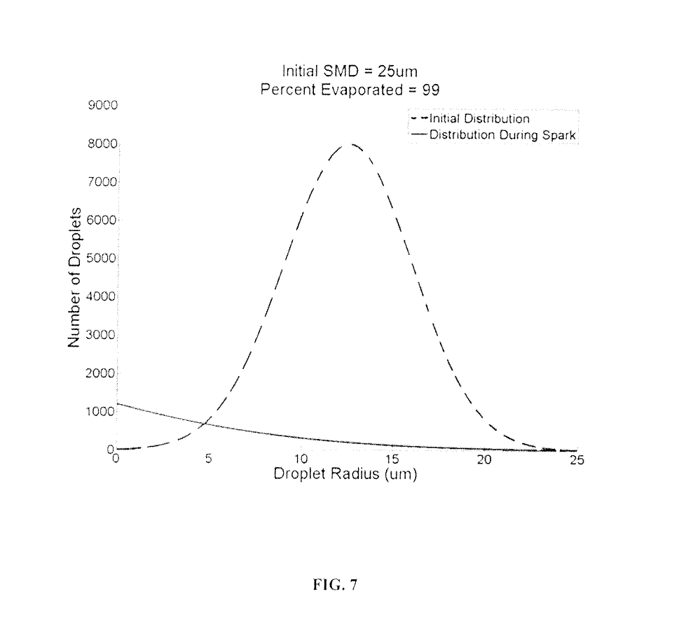

In a third embodiment, the active element has an annulus just before the orifice-containing face of the injector. Fuel passes through a thin stainless steel plate and the expansion-chamber length is chosen to maximize standing waves. See FIG. 5. Fuel injectors of varying modes, shear or thickness, and megahertz are used to reduce the size of fuel droplets. In some embodiments, injectors may operate at thickness mode frequencies (MHz) of 0.6, 1.93, 1.85, 2.95, 0.95 and at shear mode frequencies (MHz) of 1, 3.

The active element is made of PZT (i.e., Pb(ZrxTi1-x)O3) crystals operating at 2 MHz. PZT crystals are very common, cheap and durable. Piezoelectric materials with small openings have been shown to be quite effective at controlling liquid droplet size (e.g., in ink jet printers). A PZT crystal can sustain temperatures up to 350 degrees Celsius and pressures up to 10 s of MPa. It is very easy to manufacture with a fundamental frequency of 2 MHz. PZT crystals have a very high axial excursion (around 8% of its thickness), and a very high coupling coefficient, allowing for easy deposition of mechanical energy into the fuel stream. Higher axial excursions are expected from the PZT material, as opposed to prior art use of SiC-N expanding radially, resulting in the ability to apply greater force to each droplet with less power. The present invention will operate through the increase of inertial energy through momentum transfer. When the spread in inertial energy exceeds the surface energy, the droplets break apart.

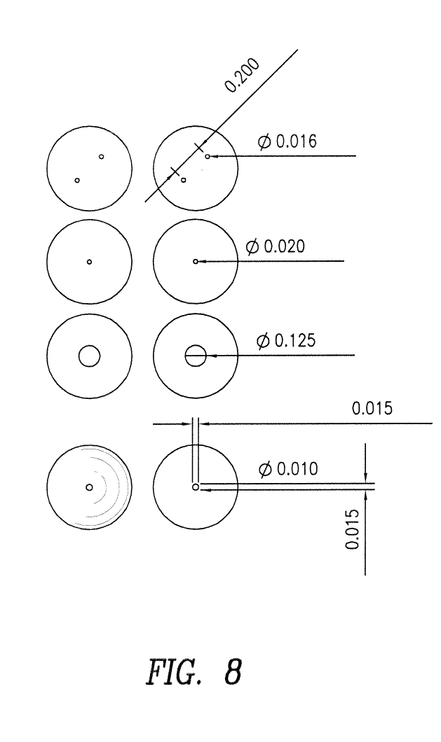

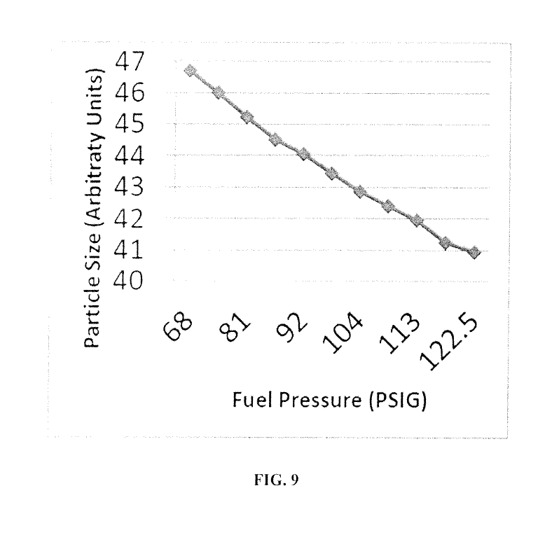

In one embodiment, as an annulus vibrating in the thickness mode inserted below the existing face plate of the injector and vibrating the plate, with frequency and fuel-expansion-chamber length chosen to maximize standing waves, the active element configuration chosen was a fuel injector orifice with a single centered hole, 0.020″ in diameter, see second plate in FIG. 8. In other embodiments the fuel-injector orifice-bearing plate includes two holes, 0.015″ in diameter, spaced 0.2″ on center, see first plate in FIG. 8 and a plate with four holes, 0.010″ in diameter spaced at the vertices of a square 0.015″ on a side. Testing on the injectors involves use of a fuel-injector test bench modified for computer control of the injector(s). The testing system qualitatively characterizes droplet-size distribution and flow rate using existing laser and high-speed optics. A droplet-sizing system has been paired with a modified fuel-injector test bench to implement testing this fuel-injector test bench which includes custom spray chamber, optics, and collected data that show a decrease in transmitted light intensity during injector open time. Initial testing to demonstrate qualitative changes in injected-droplet size is shown in FIG. 9.

Injector systems can be quickly assembled by use of an off-the-shelf pump and standard fuel-line fittings. The assembled injector test system enables testing to determine baseline performance characteristics of the selected injectors and to set targets for the performance of the modified injectors. Testing continues with the assessment of droplet-size changes induced by ultrasonic enhancement as a function of engine speed (injection frequency), engine load (injection duration), and fuel-rail pressure. Gold standard quantification of the ultrasonically enhanced fuel injection may be accomplished by utilizing existing fuel-injector spray droplet size analyzers. The present invention provides a pathway to develop optimal injector designs for various fuels, e.g., gasoline, diesel fuel, and jet fuel, and will assess performance improvements with selected engine types, e.g., for gasoline engines, fuel efficiency, output power, output torque, etc.

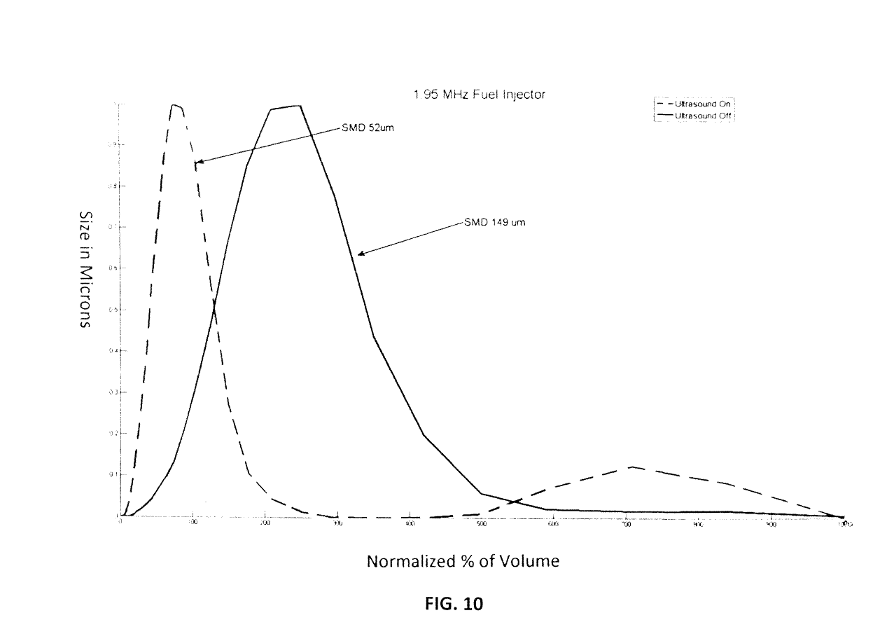

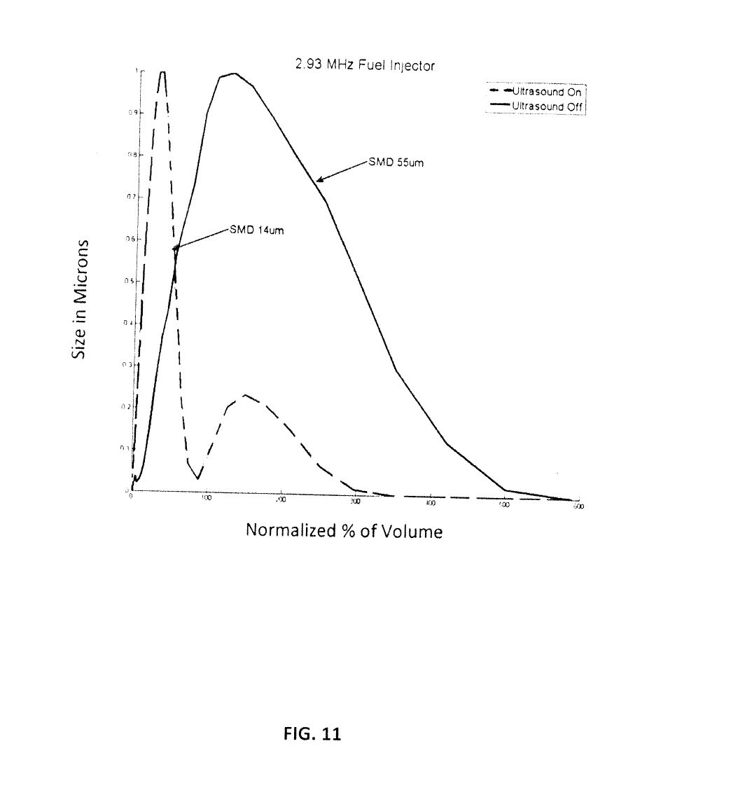

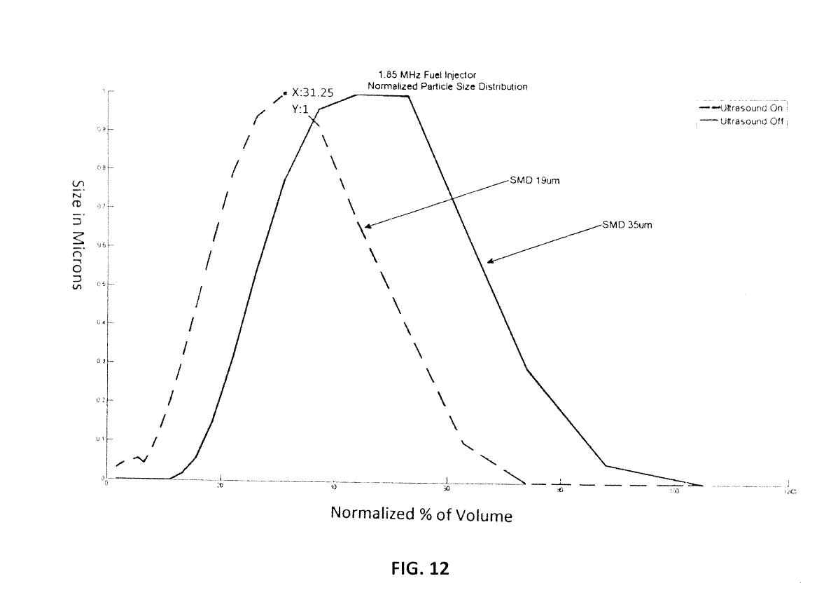

Testing performed on fuel injectors were analyzed by examining particle size distributions as shown in FIGS. 10-12 for a 1.95-MHz fuel injector, a 2.93-MHz fuel injector and a 1.85-MHz fuel injector, respectively. Each graph in FIGS. 10-12 shows sizes in microns along the y-axis and normalized percent of volume along the x-axis. In each FIG. 10-12, the particle size decreased when ultrasound was turned on. In FIG. 10 the SMD went from 149 micrometers when the ultrasound was off to 52 micrometers when the ultrasound was turned on; in FIG. 11 the SMD went from 55 micrometers when the ultrasound was off to 14 micrometers when the ultrasound was turned on; and in FIG. 12 the SMD went from 35 micrometers when the ultrasound was off to 19 micrometers when the ultrasound was turned on.

While the present invention has been described in conjunction with specific embodiments, those of normal skill in the art will appreciate the modifications and variations that can be made without departing from the scope and the spirit of the present invention. Such modifications and variations are envisioned to be within the scope of the appended claims.

I claim:

1. A method using ultrasound to reduce the size of fuel droplets comprising:
providing a fuel injector having an expansion chamber and an orifice-containing face plate with a porous PZT material arranged adjacent to the face plate passing fuel through the porous PZT material as said material is energized; and
maximizing ultrasound standing waves impacting the fuel droplets generated by said energized PZT material to reduce fuel droplet size.

2. The method of claim 1, wherein the face plate is stainless steel.

3. The method of claim 1, wherein the PZT material is a vibrating annulus.

4. The method of claim 3, wherein the PZT material vibrates in a thickness mode.

5. The method of claim 3, wherein the PZT material is disposed below the face plate.

6. The method of claim 1, wherein the PZT material is disposed before the orifice-containing face plate.

7. The method of claim 1, wherein the PZT material is disposed within the expansion chamber.

8. The method of claim 1 wherein the PZT material vibrates at a frequency of up to 3 MHz.

9. The method of claim 1 wherein fuel droplet size is reduced by between 10% and 50%.

10. The method of claim 9 wherein fuel droplet size was reduced without any increase in the fuel pressure applied to the fuel injector.

11. The method of claim 3, wherein the PZT material vibrates in a shear mode.
